(19) United States
(12) Patent Application Publication
(10) Pub. No.: US 2009/0018977 A1
(43) Pub. Date: Jan. 15, 2009

(54) FRANKING METHOD HAVING ERROR CORRECTION

(75) Inventor: Ruben RICO, Paris (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (FR)

(21) Appl. No.: 12/169,026

(22) Filed: Jul. 8, 2008

(30) Foreign Application Priority Data
Jul. 10, 2007 (FR) 0756386

(51) Int. Cl. G06Q 50/00

(52) U.S. Cl. 705/406

(57) ABSTRACT

A method of franking mailpieces in a closed franking machine fed from a mixed batch of mailpieces, said method comprising the following steps, for each mailpiece:
acquiring a digital image of the mailpiece by using optical read means;
locating a recipient's address block by using search software means;
extracting at least one item of postal data from the recipient's address block by using OCR software means;
when the at least one extracted item of postal data is not identified or is improperly identified, automatically stopping the transport of the mailpiece in the franking machine;
correcting the at least one item of postal data, the correction being performed by the user on the keyboard of a user interface of the franking machine on the basis of an image of the previously located address block, which image is displayed on a screen of the user interface; and
restarting the transport of the mailpiece in the franking machine automatically once the correction has

been validated by the user by acting on a determined validation key of the user interface.

### FIELD OF THE INVENTION

The present invention relates to the field of mail handling, and it relates more particularly to a method of franking mailpieces that have added-value postal services while avoiding any break in the real processing rate at which the batches of mail are processed.

### PRIOR ART

In order to apply added-value postal services such as registered mail, mail tracking, etc. to mailpieces, it is necessary for the operator of a postage meter or franking machine, i.e. of a franking system of the closed type, to effect various successive manual operations that, in addition to taking time, are frequent sources of error. The operator must firstly stick a label to the mailpiece, that label bearing an identifier (in general, a bar code) of the requested postal service, and then said operator must retrieve the digits corresponding to that code by inputting them into the user interface of the machine, and must match the code with the name of the recipient so as to enable the mailpiece to be tracked, and finally, said operator must input the post code or ZIP code of the recipient. A known way of accelerating this inputting process is to incorporate a scanner into the franking machine. Associated with bar code recognition software, with optical character recognition (OCR) software, and with a national database of addresses, such a scanner makes it possible to automate inputting respectively the identifier, the name of the recipient, and the post code of the recipient.

Unfortunately, although that solution appears, in theory, to be fully “automated”, in practice it is not because, since character recognition is a particularly complex operation, current OCR software, even the best OCR software, has error rates of about 5%. In view of the processing rates existing in a franking machine, such an error rate gives rise to the franking machine being stopped every 20 envelopes, thereby very considerably penalizing the processing time required for treating a batch of mail. In addition, when the address cannot be recognized, in particular in the event that it is absent from the national database or indeed when the address corresponds to an old address that has been deleted from the database but that is still valid because it is present in a change-of-address database of the postal authorities, it is necessary to disable printing of the corresponding mailpiece and to provide a routing system for re-directing it to a specific reject bin for manual processing.

### OBJECTS AND DEFINITION OF THE INVENTION

An object of the present invention is to provide a method of franking mailpieces that have added-value postal services without significantly reducing the processing rate at which the mailpieces are processed. Another object of the invention is to perform the processing without any error, without extracting certain mailpieces from the franking machine, and without changing operating modes of the machine.

These objects are achieved by a method of franking mailpieces in a closed franking machine fed from a mixed batch of mailpieces, said method comprising the following steps, for each mailpiece:
acquiring a digital image of the mailpiece by using optical read means;
locating a recipient's address block by using search software means;
extracting at least one item of postal data from said recipient's address block by using OCR software means;
when said at least one extracted item of postal data is not identified or is improperly identified, automatically stopping the transport of the mailpiece in the franking machine;
correcting said at least one item of postal data, the correction being performed by the user on the keyboard of a user interface of the franking machine on the basis of an image of the previously located address block, which image is displayed on a screen of said user interface; and
restarting the transport of the mailpiece in the franking machine automatically once the correction has been validated by the user.

Thus, with this direct correction by the user, it is no longer possible for errors to exist in recipient address recognition, and the mailpieces can thus be processed more quickly and thus at lower cost.

In a first variant, when the image displayed on the screen of said user interface is not the image of the recipient's address block, then, by means of a determined function key of said user interface, the user actuates a step of automatically and successively viewing other zones of the digital image of the mailpiece, which other zones might contain said recipient's address block, on said user interface, before performing the step of correcting said at least one item of postal data.

In a second variant, when the image displayed on the screen of said user interface is not the image of the recipient's address block, then, by means of display scroll buttons on said user interface, the user performs a manual step of searching for the recipient's address before performing the step of correcting said at least one item of postal data.

Depending on the application, said at least one item of postal data can be at least one of the following items of postal data: the name of the recipient, the post code of the recipient, and the country of destination.

Preferably, said post code is printed on the mailpiece in the form of a bar code such as the POSTNET code.

Advantageously, each of the mailpieces bears an identifier relating to the added-value postal service desired for said mailpiece. Said identifier comprises a bar code printed on a label stuck to the mailpiece and read by bar code recognition software means of the franking machine, or said identifier is printed on the mailpiece during printing of the postal imprint.

In a particular implementation, the identifier and said at least one item of postal data are stored in a database of the franking machine, and optionally, the image of the mailpiece is also stored therein.

### BRIEF DESCRIPTION OF THE DRAWINGS

The characteristics and advantages of the present invention appear more clearly from the following description given by way of non-limiting indication and with reference to the accompanying drawings, in which:

FIGS. 1 to 4 show successive operating configurations of a franking machine for franking mailpieces; and

FIG. 5 is a flow chart showing an example of the method of the invention for franking mailpieces as implemented in the franking machine of FIGS. 1 to 4.

### DETAILED DESCRIPTION OF A PREFERRED IMPLEMENTATION

The invention proposes to reduce significantly the processing time required for processing mailpieces, in particular those having added-value services (without however being limited to this particular application), and to eliminate the human error that is associated with a fully manual procedure, by implementing a method that can be termed “semi-automatic” and that is applicable to conventional franking machines and in which any envelope placed in the feed module of the franking machine is necessarily franked. In other words, under no circumstances is an envelope extracted from the machine for manual processing. With the invention, errors no longer exist because the transition between the automatic process and the manual process is managed by a specially designed user interface.

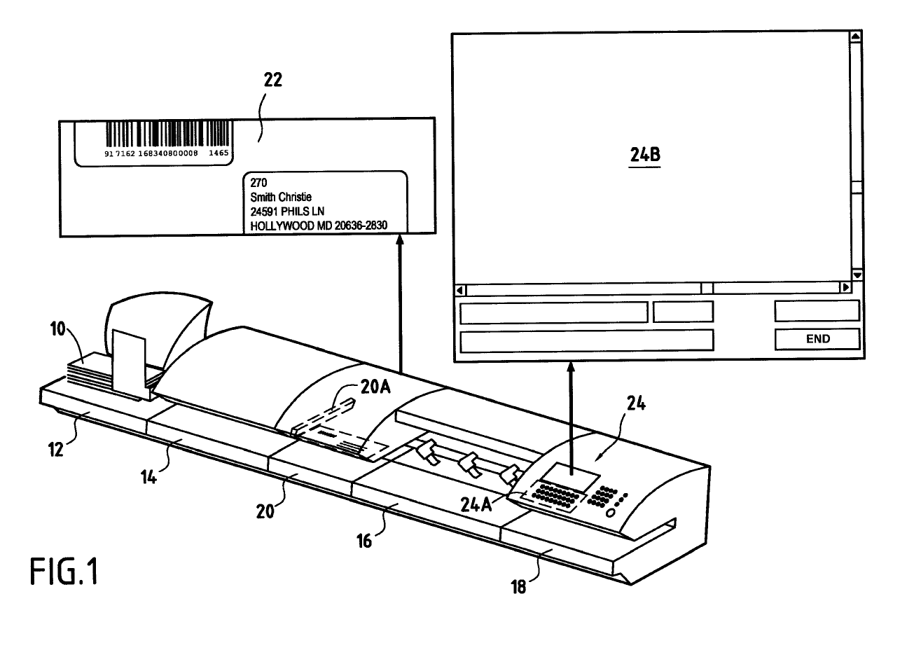

FIG. 1 shows a franking machine that comprises, in conventional manner, from upstream to downstream in the advance direction for the mailpieces 10: a mailpiece feed module 12 designed to receive a stack of mailpieces that are typically mixed mailpieces (i.e. of different dimensions and weights), each of which, in the example shown, bears an identifier relating to an added-value postal service desired for the mailpiece (conventionally, this identifier is borne on a label previously stuck to the mailpiece); a selection and transport module 14 for selecting and transporting the mailpieces one-by-one; a dynamic weigh module 16 for determining the weight and optionally the dimensions of each selected mailpiece; and a print module 18 designed to print a postal imprint on each of the mailpieces selected one-by-one and weighed in this way. In known manner, the franking machine is preferably connected to a server (not shown) of a dealer of the machine, which dealer's server is itself connected to a server (not shown) of the postal authorities or of a private carrier delivering the mail.

In accordance with the invention, this mail handling system further comprises an optical read module 20 having a sensor 20A that is advantageously linear and of the “contact” type, thereby enabling it to be incorporated very well into the machine at low cost, but that is shown outside the module merely for reasons of understanding of the invention. The read module 20 is placed upstream from the dynamic weigh module (although the use of an integrated module at the outlet of the selection module or at the inlet of the weigh module is also quite possible), and it serves to acquire a digital image 22 of the mailpiece and to extract therefrom the identifier relating to the added-value service desired for the mailpiece and the recipient's address borne by the mailpiece. For this purpose, the image acquisition module is associated with bar code recognition and OCR software. In accordance with the invention, the franking machine further comprises an improved user interface 24 with a keyboard 24A making it possible to display, on a screen 24B, all or some of the image of the mailpiece that is scanned in this way and, if necessary, to correct the postal data extracted from said image. The keyboard 24A can be a physical keyboard or a virtual keyboard on the screen 24B which is then advantageously of the touch-sensitive type.

The franking machine can also comprise storage means (not shown) of the database type for storing the image of the envelope that is scanned in this way. The image is associated in the database with the corresponding identifier borne on the mailpiece and with the data extracted from the address of the recipient. Said storage means can advantageously incorporate one or more databases (not shown) containing the list of the addresses of the mailpieces to be sent during a given franking session, and updated while they are being established (e.g. by means of document processing software) or indeed a full list of all of the addresses of the user's contacts (customer database).

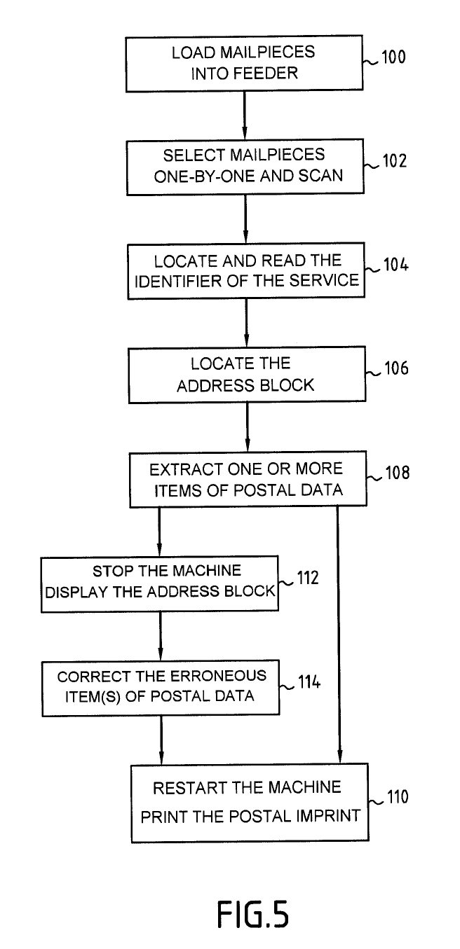

The franking method of the invention that is implemented in the above-mentioned franking machine is described more particularly below with reference to FIG. 5, in association with FIGS. 1 to 4. In the application example shown, each of the envelopes to be franked is preferably previously provided with a label bearing an identifier of its added-value service. FIG. 1 shows the first step 100 (FIG. 5) in which the envelopes 10 are inserted in stacks into the franking system at the feed module 12 thereof. Thereafter, in a second step 102, the envelopes are selected one-by-one are scanned by the optical read module 20. An example of the result of the scanning is shown by the image of the envelope that is referenced 22. Reference 24B shows the user interface just before the image is scanned and thus still blank, showing no graphics representation.

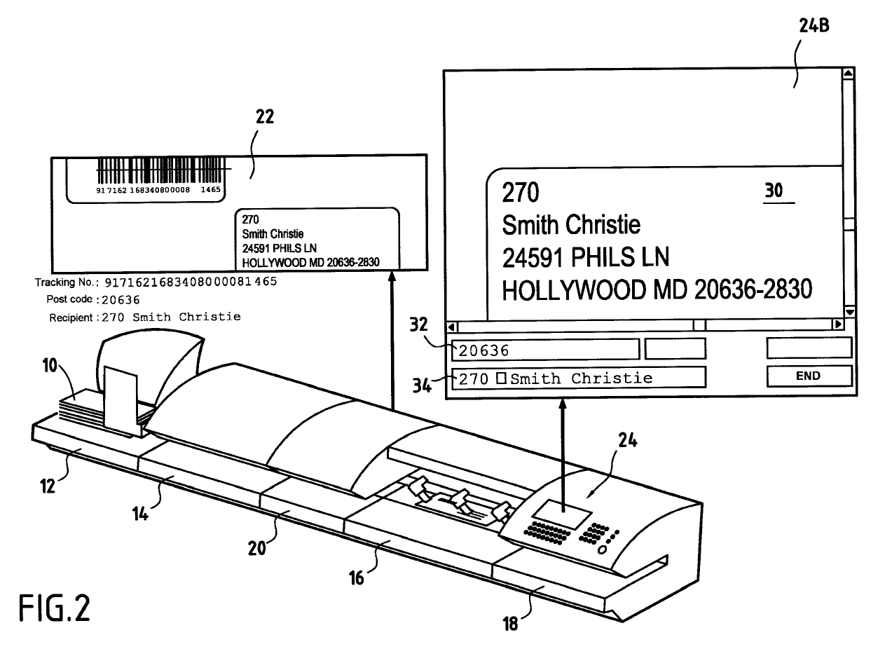

The next steps of the method shown in FIG. 5 are shown correspondingly in FIG. 2. In a step 104, the identifier (tracking No.) is located and identified by means of the bar code recognition software, and, in a step 106, the address block printed on the envelope is located by means of address block search software. In step 108, the OCR software extracts one or more items of postal data from the address block recognized in this way, e.g. the name and/or the post code of the recipient and/or the country of destination (without these items of data being limiting). If the confidence rating of the OCR software is greater than a predefined threshold, the envelope continues along its path towards the print module, where the postal imprint is printed in a step 110. Conversely, if said confidence rating is lower than said threshold, then the envelope is stopped along its transport path at the dynamic weigh module 16 before it reaches the print module 18, and, in a step 112, the image 30 of the address block is displayed on the user interface 24, as shown, and, recognized characters 32 of the post code of the recipient and recognized characters 34 of the name of the recipient are displayed in respective ones of at least two separate fields 32, 34 on the said user interface. Naturally, other fields (not shown) could be provided for receiving recognized characters of other postal data of the address block such as the street or the country of destination.

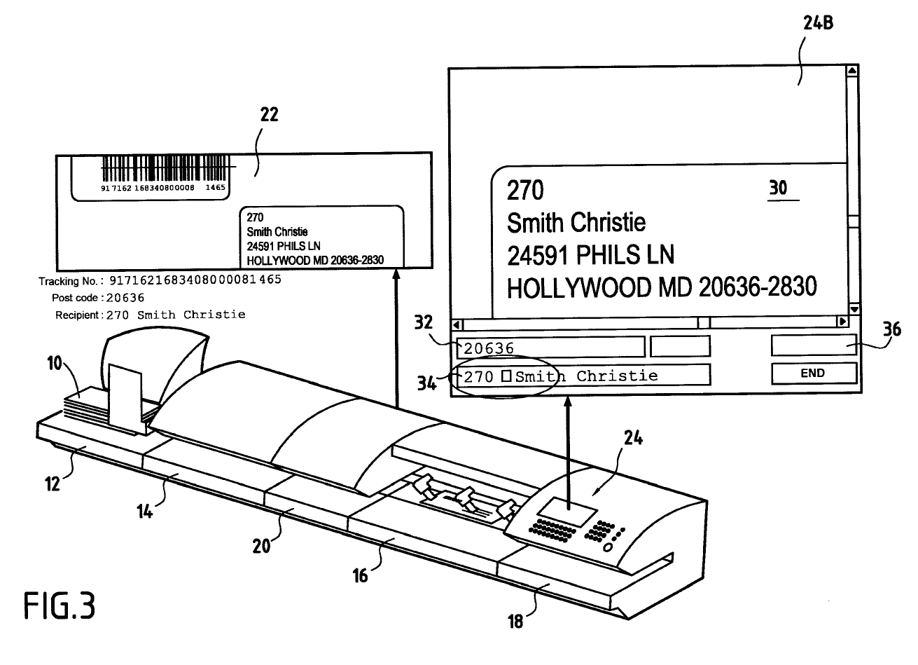

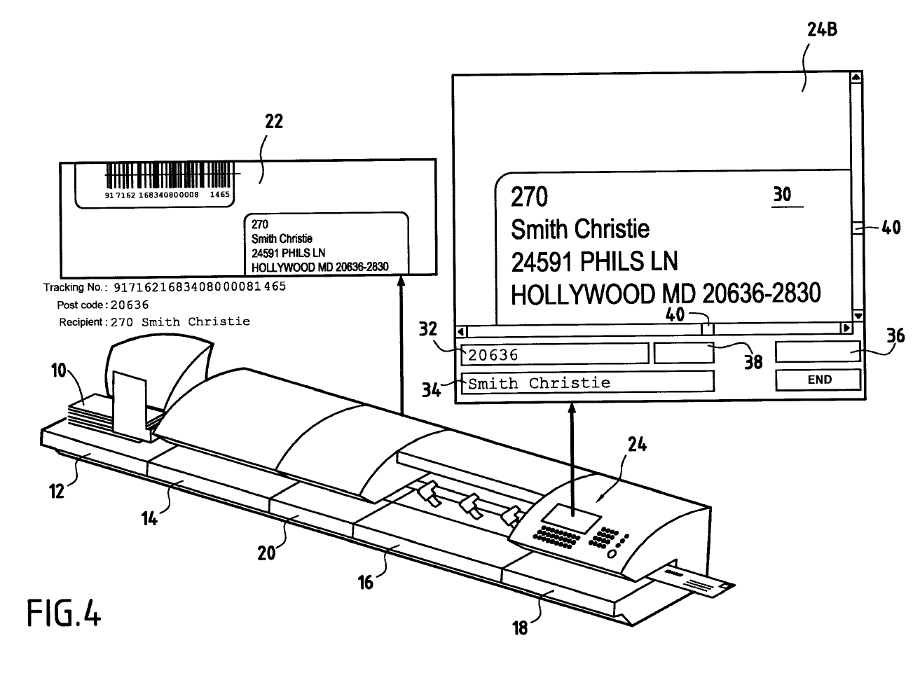

As shown in FIGS. 3 and 4, the operator can then, in another step 114 (FIG. 5), act on the keyboard 24A of the user interface so as to correct, if necessary, the “post code” and/or “name” of the recipient fields, to match the items of postal data of the address block that are displayed on the screen 24B. In this example, the numeral 270 and the comma between the surname and the forename of the recipient are deleted from the “name” field because they are meaningless. By acting on a validation key 36, it is possible to validate the corrections made, and the envelope can resume its journey along its path towards the print module so as to be franked thereat (return to step 110).

It should be noted that the user can be assisted in performing the correction step. In particular, when the displayed image is not the image of the recipient's address block, provision is made, by means of a determined function key 38, for a step to be performed in which other zones of the digital image of the mailpiece that might contain the recipient's address block and that were previously located by the search software are viewed automatically and successively (in practice, such zones bear sets of alphanumeric characters). Once the block has been selected, the user can make the correction, as above. Similarly, display scroll keys 40 are provided for shifting the display on said user interface so that, if searching successively through the blocks fails, then a manual search can be made for the recipient's address block, prior to performing, as above, the step of correcting the erroneous postal data, e.g. the name and/or the post code of the recipient.

At the end of the correction step, the identifier, the name, and the post code of the recipient (and optionally also the country of destination) are preferably stored in the database of the franking machine, preferably together with the digital image of the envelope or merely with the digital image of the address corresponding to said envelope. Periodically, and at the latest at the time the mail is collected, the content of said database is sent automatically to the dealer's server which forwards it to the postal authorities' server (or the private carrier's server), or merely makes it available to that server so as to make it possible to perform the mailpiece tracking operations that are associated with the added-value postal service chosen by the sender of the mailpieces. The dealer's server also receives updates from the postal authorities' server on the progress of each mailpiece (e.g. sending pending, sent, etc.). In this way, the sender can connect to the dealer's server (in particular via a Web client) in order to determine the progress of the sender's mailpieces, by making a request either by tracking number, or by recipient name, or indeed by date.

It should be noted that the correction step performed by the user can be limited merely to a correction of the name of the recipient, in particular when the mailpiece bears a bar code such as the POSTNET code. In such circumstances, the extraction of the post code is totally reliable and no manual correction to said post code is then necessary on the keyboard of the user interface. The same applies when the franking machine incorporates one or more address databases and search software that makes it possible to verify that the post code is consistent with the city and optionally with the country of destination. Any errors can be corrected by redundancy between a plurality of fields of the address block.

When said database is a customer database that associates the name of the recipient with the address, it is possible for the search software to verify automatically whether the name of recipient complies. This situation avoids stopping for verification, and makes the process completely automatic if the software recognizes the “name” and “post code” fields in the customer database.

With the invention, in the event of non-recognition, it is no longer necessary to extract the unrecognized envelope from the machine in order to read the address on it, to input the name and the post code on the user interface of the machine, and to re-load the envelope into its feed module after changing the operating mode of the machine (going over from batch processing to standard processing) so that it is franked individually. Displaying the address block directly on the user interface makes it possible to make the necessary correction without changing the operating mode of the machine that resumes operation as before (and thus in the same operating mode) once the correction has been validated. Such a stop for correction does not significantly penalize the mailpiece processing rate which, even with such stops, is considerably higher than in the prior art in which it is necessary for each unrecognized envelope to be processed manually.

It should be noted that the invention is also applicable to tasks other than tracked mail handling and, in particular, when it is necessary to read the elements of the address, e.g. for computing the postage price as a function of the destination (post code or country).

What is claimed is:

1. A method of franking mailpieces in a closed franking machine fed from a mixed batch of mailpieces, said method comprising the following steps, for each mailpiece:
acquiring a digital image of the mailpiece by using optical read means;
locating a recipient's address block by using search software means;
extracting at least one item of postal data from said recipient's address block by using OCR software means;
when said at least one extracted item of postal data is not identified or is improperly identified, automatically stopping the transport of the mailpiece in the franking machine;
correcting said at least one item of postal data, the correction being performed by the user on the keyboard of a user interface of the franking machine on the basis of an image of the previously located address block, which image is displayed on a screen of said user interface; and
restarting the transport of the mailpiece in the franking machine automatically once the correction has been validated by the user by acting on a determined validation key of said user interface.

2. A method of franking mailpieces according to claim 1, wherein, when the image displayed on the screen of said user interface is not the image of the recipient's address block, then, by means of a determined function key of said user interface, the user actuates a step of automatically and successively viewing other zones of the digital image of the mailpiece, which other zones might contain said recipient's address block, on said user interface, before performing the step of correcting said at least one item of postal data.

3. A method of franking mailpieces according to claim 1, wherein, when the image displayed on the screen of said user interface is not the image of the recipient's address block, then, by means of display scroll buttons on said user interface, the user performs a manual step of searching for the recipient's address before performing the step of correcting said at least one item of postal data.

4. A method of franking mailpieces according to claim 2, wherein said at least one item of postal data is at least one of the following items of postal data: the name of the recipient, the post code of the recipient, and the country of destination.

5. A method of franking mailpieces according to claim 4, wherein said post code extracted from the recipient's address block is verified by means of a first database containing all of the addresses of the contacts of the user.

6. A method of franking mailpieces according to claim 4, wherein said post code is printed on the mailpiece in the form of a bar code such as the POSTNET code.

7. A method of franking mailpieces according to claim 1, wherein each of the mailpieces bears an identifier relating to the added-value postal service desired for said mailpiece.

8. A method of franking mailpieces according to claim 7, wherein said identifier comprises a bar code printed on a label stuck to the mailpiece and read by bar code recognition software means of the franking machine.

9. A method of franking mailpieces according to claim 7, wherein said identifier is printed on the mailpiece during printing of the postal imprint.

10. A method of franking mailpieces according to claim 7, wherein the identifier and said at least one item of postal data are stored in a second database of the franking machine.

11. A method of franking mailpieces according to claim 10, wherein the image of the mailpiece is also stored in said second database.
